(19) United States
(12) Patent Application Publication
(10) Pub. No.: US 2014/0101873 A1
(43) Pub. Date: Apr. 17, 2014

(54) TIRE DRESSING OR CLEANING APPARATUS WITH A PLURALITY OF MOUNTED ROTATING BRUSHES

(71) Applicant: Sonny's Enterprises, Inc., Tamarac, FL (US)

(72) Inventors: Anthony Analetto, Weston, FL (US); Paul Fazio, Weston, FL (US)

(73) Assignee: Sonny's Enterprises, Inc., Tamarac, FL (US)

(21) Appl. No.: 14/054,720

(22) Filed: Oct. 15, 2013

Related U.S. Application Data
(63) Continuation of application No. 13/005,308, filed on Jan. 12, 2011, now abandoned.

(51) Int. Cl. B60S 3/04

(52) U.S. Cl. CPC B60S 3/042
USPC 15/53.4

(57) ABSTRACT

An apparatus for dressing and/or cleaning tires of a vehicle. The apparatus has a plurality of brushes in a line, at least some of which further apply fluid onto the tire.

### CROSS-REFERENCE TO RELATED APPLICATIONS

This application claims priority to U.S. Provisional application Ser. No. 61/294,797, filed Jan. 13, 2010, which is hereby incorporated herein by reference in its entirety.

### FIELD OF THE INVENTION

The present invention relates generally to an apparatus for dressing and/or cleaning vehicle tires and, in particular, to a method and an apparatus for automatically applying a dressing or cleaning fluid to the tires of a vehicle being conveyed within an automatic washing facility.

### BACKGROUND OF THE INVENTION

It is well known in the vehicle washing industry to perform various automated steps during the vehicle washing process as the vehicle is conveyed through a washing facility. Over the years, numerous advances to such washing facilities have expedited and improved the washing process while decreasing the labor requirements of the facility. For instance, the development of a cost-efficient, effective air drying system for vehicles largely eliminated the need to dry vehicles manually alter the washing procedure is completed.

Historically, patrons to vehicle washing facilities may have had the option of having a dressing or cleaning fluid applied to the vehicle tires. The dressing, which might be either water-based or some non-aqueous solvent-based, is applied directly to the tires to improve their appearance and provide a finishing touch to the exterior of the vehicle, While there are various known methods for applying tire dressing fluids, it is desirable to reduce manpower requirements or improve the efficiency with which the dressing fluids are consumed by the washing facility.

One method of dressing vehicle tires is by manually applying the dressing as the vehicle approaches the washing facility exit or when the car has been moved outside the washing facility. In an inherently labor intensive process, an attendant applies the fluid manually to each tire. Understandably, there is difficulty in controlling the amount of tire dressing fluid that is used by the attendant. One attendant may apply the fluid liberally to the applicator pad or towel, while another attendant may not use enough fluid. The result is that patrons may receive inconsistent service, and the cost of the tire dressing service is unnecessarily inflated to cover the cost of manpower and the dressing fluid consumed by the facility.

There have also been attempts to apply the dressing fluid automatically as the vehicle is prepared to exit the washing facility. Typically, one of more spray nozzles are used to spray fluid directly on the tires. While an automatic spraying device may eliminate the manual step of applying the fluid, spraying the tires creates other problems.

A major problem is that the tires and wheels arc usually sprayed together, so a large quantity of dressing fluid is immediately wasted when the wheels are sprayed. The tires mast then be wiped, and fluid must be removed completely from the wheels since some fluids cart corrode certain types of wheels. As a reside instead of reducing manpower requirements by spraying tires with fluid, the amount of manual labor may actually be increased by the wiping requirements or where not wiped, the fully-automated apparatus may yield tires that are not as clean or attractive. There may be additional cost associated with products such as towels and gloves needed by the attendants to wipe down the tires and wheels.

Another problem with spraying tires with fluid is that the attendants who subsequently wipe the wheels and tires often do so outside the facility, which allows fluid to drip from the tires arid wheels before the vehicle reaches the attendant. Especially in the winter, fluid on the ground may pose a problem. There may also be environmental concerns when dressing fluid drains from the washing facility property.

Some automatic apparatuses first apply the cleaning fluid onto a sponge and then wipe it onto the tire. However, the different shapes of various tires create issues. For example, for smaller tires, too much cleaning product may get on the rim of the tire. For larger tires, the entire tire might not he cleaned. In addition, the entire sponge has to he replaced if it is damaged or simply wears out.

Yet other apparatuses spray the cleaning fluid onto a longitudinal brush. This process tends to waste cleaning fluid and apply a blotchy coat to the tires.

The present invention is directed to an apparatus, and a method for its use, which effectively cleans tires and further efficiently applies a dressing and/or cleaning fluid to vehicle tires in a vehicle washing facility.

### SUMMARY OF THE INVENTION

In one aspect, an apparatus for cleaning a tire of a vehicle without a fluid application is provided. The apparatus has: a plurality of brushes, a support, a motor and a drive train assembly. The brushes are preferably mounted generally horizontally to said support, and at least some of the brushes are rotated on an axis generally orthogonal to the path of the tire. The brushes may all be interconnected to each other through the drive train assembly to each turn.

In another aspect, the foregoing apparatus applies a fluid to a tire of a vehicle, in order to dress and/or clean the tire. This embodiment has a support adapted to be mounted adjacent to and parallel to a path of tire travel, A plurality of hollow shafts, each adapted to be mounted to the support and substantially perpendicular to the path of tire travel serve to respectively mount a plurality of brushes in a serial relationship (a line). The brushes preferably are made of bristles. The bristles can be substantially perpendicular to the path of tire travel. A drive motor rotates the rotatable brushes, with gears in this version serving to transfer rotary motion and to interconnect the brushes. Fluid is metered through the hollow shafts to the brushes as required.

In yet another aspect, an apparatus for dressing or cleaning and applying a fluid to tires of a vehicle is provided having: a plurality of left-side brushes and a plurality of right-side brushes having opposed (or inboard) inner surfaces, which lace the sides of the vehicle. The respective inner surfaces are engageable with at least one tire on a left or right side of the vehicle, respectively. The brushes have outer (or outboard) surfaces mounted respectively to left and right supports. A motor rotates the respective left brushes and right brushes. The brushes are arranged generally in a row on each side, and in this embodiment are connected to each other by a plurality of gears and a plurality of hollow shafts are used for mounting the brushes to the supports, as well as for delivering the fluid to the brushes.

In an additional aspect, a process for applying a fluid to at least one tire of a vehicle is provided, the process comprises providing a fluid to a plurality of brushes mounted on a generally horizontal support, preferably through a plurality of hollow shafts. At least some of the plurality of brushes are rotated with a drive motor, as by interconnection with a plurality of gears. the plurality of brushes are then engaged with a tire.

In yet another aspect, an apparatus for dressing or cleaning tires of a vehicle in a carwash is provided. This apparatus has a mount having a long dimension. A plurality of brushes carried on the mount, at least some of which are arranged generally along the long dimension, have an axis extending away from and oh a side of the mount. Some or all of the brushes are mounted to rotate on the axis. A drive train is connected to the brushes and a motor is connected to the drive train to drive the brushes. A conduit structure may further be provided, through which a dressing fluid or the like may be conveyed to some or all of the brushes. This conduit structure in an embodiment ends in an axle or a hollow shaft of the foregoing brushes. The axle or hollow shaft also serves as the brush axis.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of an apparatus for applying a fluid to or cleaning tires of a vehicle, in accordance with an illustrative embodiment.

FIG. 2 is a perspective view of an apparatus for applying a fluid to or cleaning tires on both sides of a vehicle, in accordance with an illustrative embodiment.

FIG. 3 is a top, somewhat schematic view of a support tor an apparatus shown in FIG. 1 for applying a fluid to or cleaning tires, in accordance with an illustrative embodiment.

FIG. 4 is an enlarged perspective view of a brush for an apparatus of the type of FIG. 1.

FIG. 5 is a perspective view of a hollow shaft for use with an apparatus of the type of FIG. 1.

FIG. 6 is a schematic perspective view of a drive brush gear for an apparatus of the type of FIG. 1.

FIG. 7 is a schematic perspective view of a brush gear tor an apparatus of the type of FIG. 1.

FIG. 8 is a top schematic view showing conduit structure for fluid delivery for an apparatus of the type of FIG. 1.

### DETAILED DESCRIPTION OF AN EMBODIMENT OF THE INVENTION

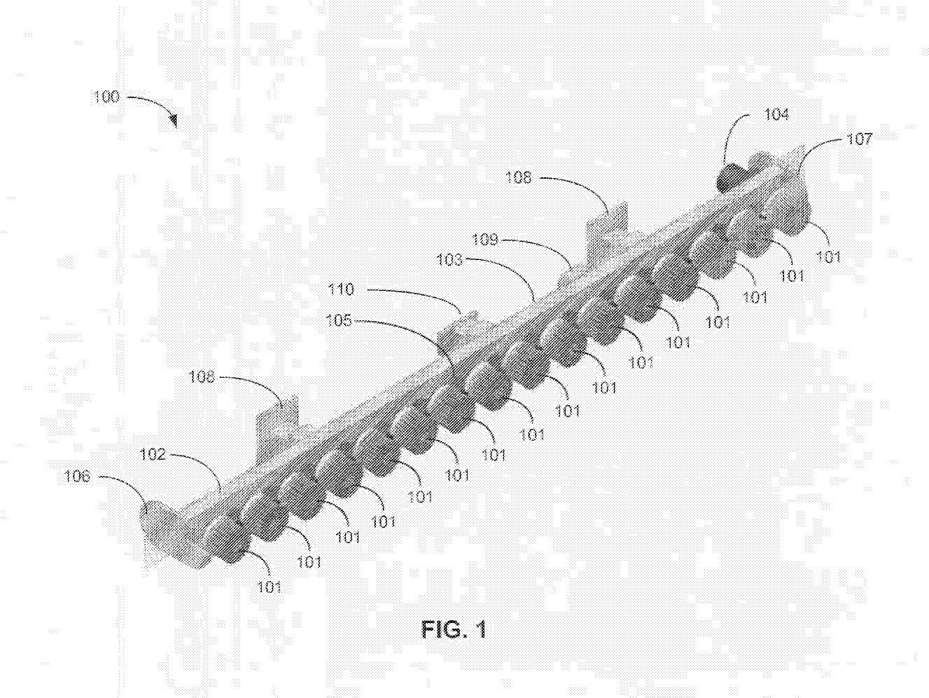

In one aspect, an apparatus for dressing and/or cleaning tires on a vehicle and particularly with the application of fluid to the tires is provided. The apparatus so described uses brushes to effectively and efficiently apply a fluid to a tire or tires in a vehicle washing facility immediately, such as after the vehicle is washed. These brushes may advantageously be easily and inexpensively made, and replaced if damaged. FIG. 1 shows an apparatus 100 for dressing or cleaning as well as for applying a fluid to tires, in accordance with an illustrative embodiment of the invention. The fluid may be a fluid typically used in the car-wash industry. For example, the fluid may be a tire dressing fluid or a tire cleaning fluid. As noted earlier, however, tire-cleaning alone is contemplated, without a dressing being applied.

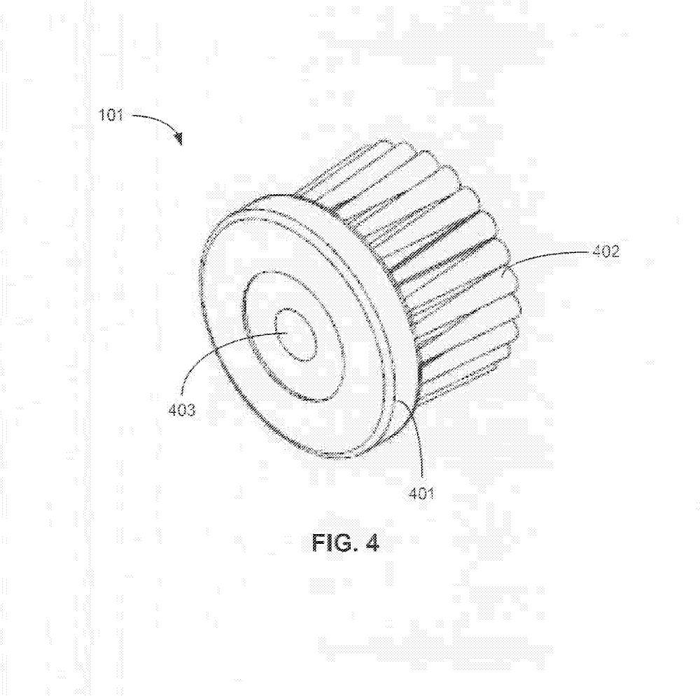

Here, the apparatus 100 has a plurality of brushes 101 mounted on a support 102. A more detailed view of a brush 101 is shown in FIG. 4. In this embodiment, the apparatus 100 includes sixteen brushes 101, but other illustrative embodiments may include more or fewer brushes depending on the situation. The brushes 101 have a circular shape with a diameter of about five inches. Each brush 101 is substantially the same size.

When the brushes 101 contact the tire, pressure is applied toward the tire and causes the brushes 101 to expand or “fan out” to a diameter of about six inches. In this example, when the brushes 101 have five inch diameters, the support 102 is about 96 inches in length, such that sixteen brushes 101 fit on the support 102. These smaller diameter brushes in a plurality as described give a desirable and improved cleaning, as well as easier maintenance of the system. The bristles of the brushes allow for easy cleaning of crevices in tires. As will be further described, an improved application of dressing is also yielded.

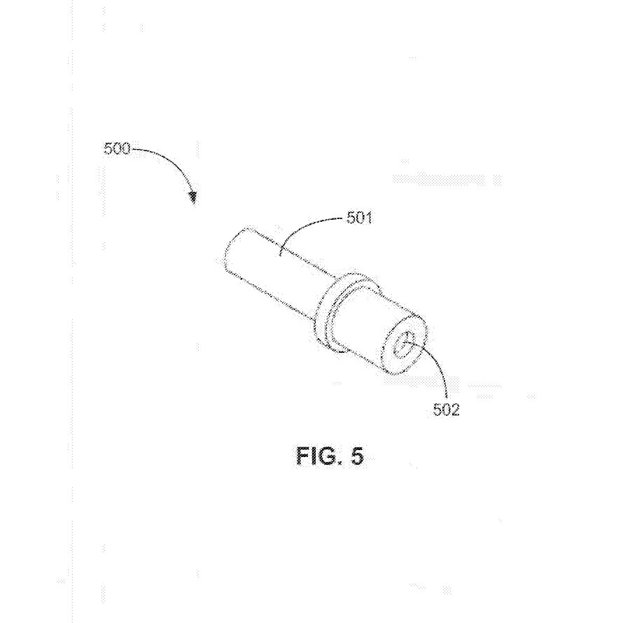

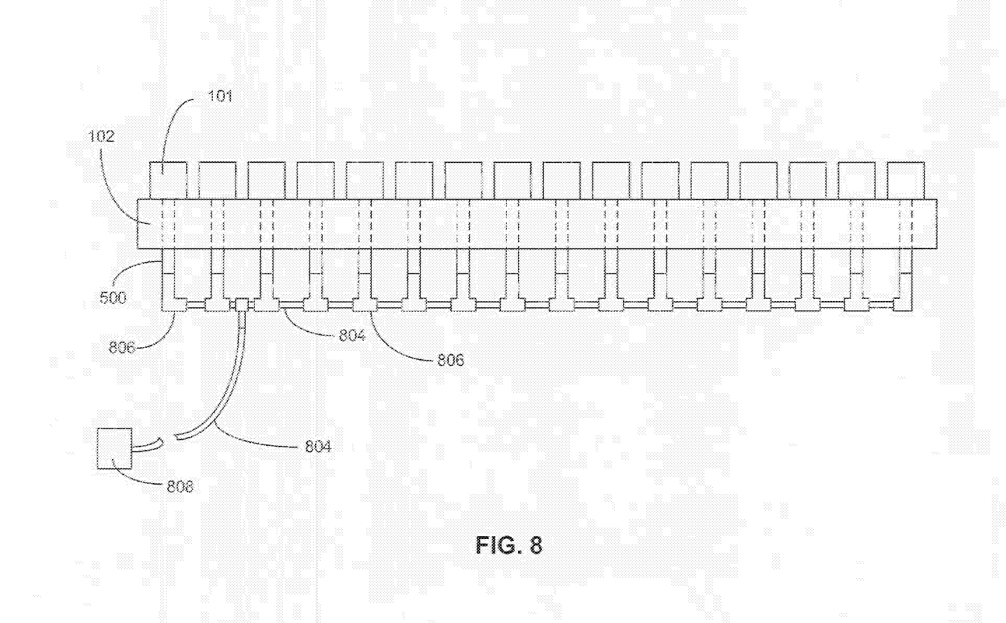

The brushes 101 are mounted to the support 102 with hollow shafts as best shown in FIG. 5. The hollow shafts are preferably mounted substantially parallel to a floor or a conveyor, such that the hollow shafts extend horizontally from the support 102. They need not be exactly horizontal or orthogonal, however, and some angulation may even have its own advantage. The brushes 101 comprise bristles, which may extend substantially parallel to the axis of the brush. The shafts are hollow to deliver the fluid to the brushes 101, such that when the brushes 101 contact the sire, the fluid is dispensed from the brushes 101. The fluid is delivered through the hollow shafts to the base holding the bristles of the brushes 101 using the tubing 804 in FIG. 8. This tubing 804 forms a conduit structure for the fluid delivery to the brushes 101. Fluid is metered into the tubing 804 through one (as here) or more entry points, prior to entering the hollow shafts 500. The tubing 804 is connected to the hollow shafts 500 with connectors 806, which may be T-shaped or L-shaped connectors. The tubing 804 delivers fluid from a metering chamber 808 to the hollow shafts 500, which in turn delivers fluid to the brushes 101. Fluid could be delivered in other ways to the brushes, as by a drip from above each brush. Then again, not all brushes need to have a fluid component, nor do all brushes have to rotate.

The fluid application may be controlled by an adjustable programmable logic controller (PLC). The PLC may control the amount of chemical applied based on the number of ears requesting the service.

The apparatus 100 may also include a manifold 103. The manifold 103 here has a hinged lid. The manifold 103 might also include the hollow shafts, with conduit structures defined by the manifold 103 itself rather than from the tubing 804 shown in FIG. 8.

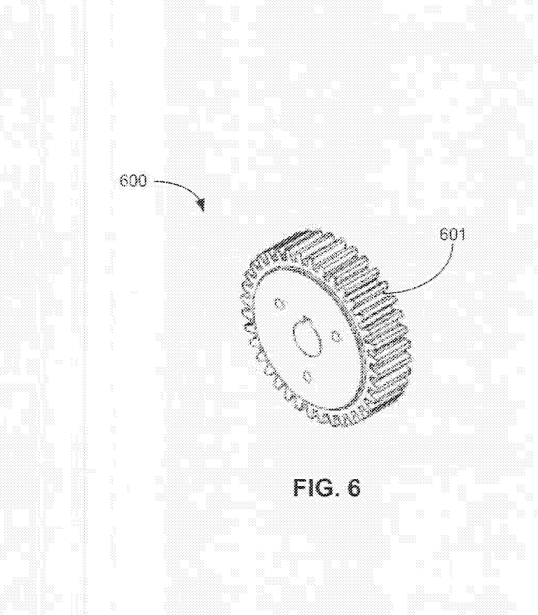

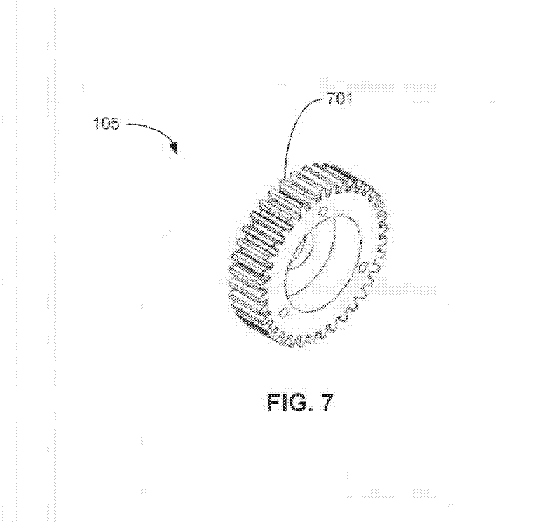

A motor 104 rotates the brushes 101. The motor 104 may be, for example, an electric motor. The motor 104 has its output connected to a drive gear similar to the drive gear 600, best shown in FIG. 6. The motor 104 rotates a drive gear 600 on a first brush in the line. The brushes 101 may rotate in a clock-wise or counter-clockwise direction, or could be organized to go in either or both directions in the line. The drive gear 600 is interconnected with the other brushes 101 through engagement with brush gears 105, as best shown in FIG. 7. These brush gears 105 are mounted to transfer the rotary drive motor train drive gear 600 through the rest of the gears connected to the brush mounts.

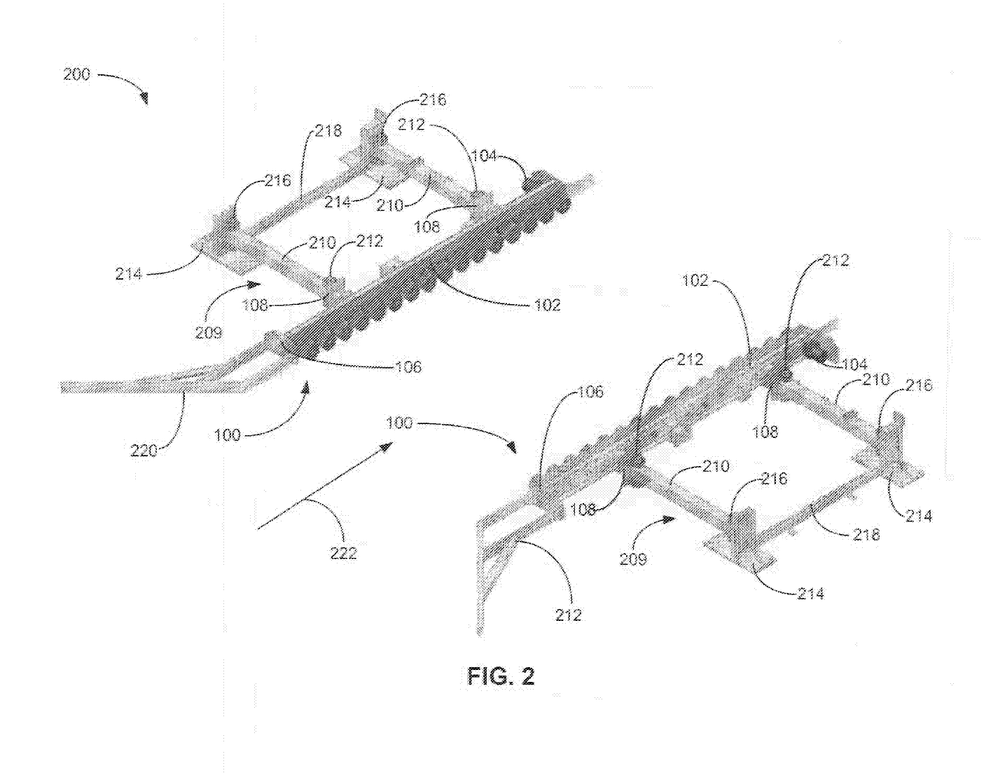

FIG. 2 shows both sides of an apparatus 200 for dressing and/or cleaning and applying a fluid to tires of a vehicle, in accordance with an illustrative embodiment. The apparatus 200 comprises a tire dressing and/or cleaning apparatus 100 for one side and another apparatus 100 for the other side.

A movable frame 209 carries the support 102. The frame 209 has two arms 210. These arms 210 are connected to the support 102 at rod mounts 108 with first pivot pins 212. The arms 210 are attached to the floor via anchor plates 214 and second pivot pins 216, such that they are substantially parallel to each other. The anchor plates 214 are connected to each other with a mount bar 218, which is substantially parallel to the support 102. The pivot pins 212 and 216 allow the arms 210, the support 102, and the mount bar 218 of apparatus 100 to move into a parallelogram formation. In other illustrative embodiments, the arms 210, the support 102, and the mount bar 218 maybe in different formations.

The frame 209 is connected to the support 102 with rod mounts 108, such that the frame 209 is substantially parallel to the floor. The height of the frame 209 could be made adjustable according to the size of the tire. A hydraulically or pneumatically driven swing arm 220 connects to the support 102, as at entrance attachment plate 106. The swing arm 220 is attached to a motor (not shown) and a drive assembly, which serves to pivot the swing arm 220 arid the frame 209, and therefore the apparatus 100 into position against a tire. The swing arms 220 may move the opposing apparatuses 100 in a parallelogram formation, rotating the apparatuses on pivot pins 212 and 216. In other illustrative embodiments. It may be desirable to move the opposing apparatuses 100 in a different formation. This movement may be controlled by whether the operator has been paid by the vehicle owner for the dressing and/or cleaning, for instance. In an illustrative embodiment, the swing arm 220 and the motor 104 are controlled by a control system. Such control systems are well-known in the industry, such as the model MTC controller made by MacNeil Wash Systems discussed in United Slates Patent Application Publication 2009/0241989.

A vehicle is conveyed in between the opposed dressing and/or cleaning apparatuses 100 in the direction of arrow 222. A conventional track may be used to convey the vehicle. The track may include an arrangement of components, including a roller drive, computer control system, and other conveying equipment, which are considered well-known in the art.

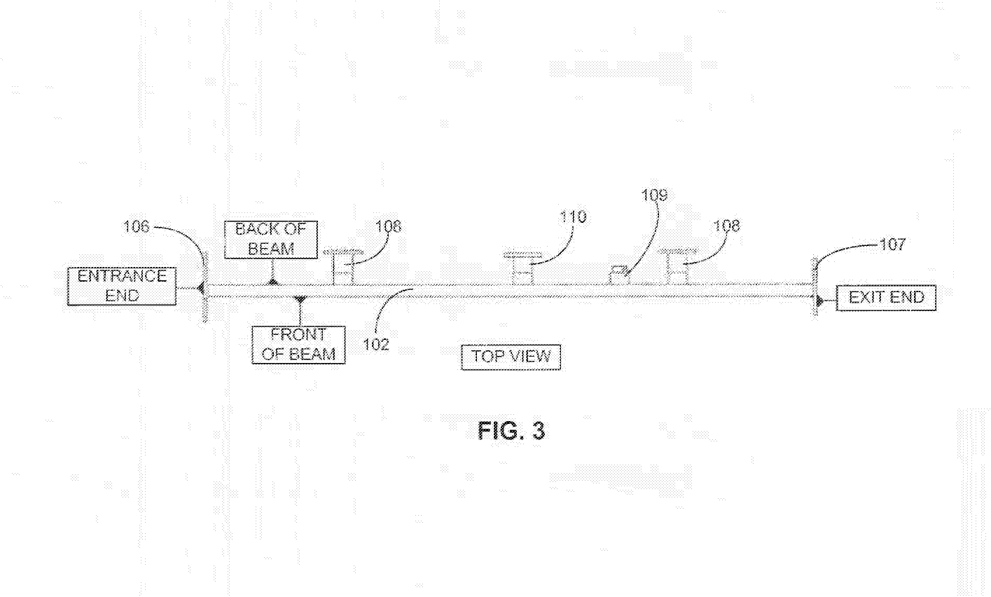

FIG. 3 shows a top view of the support 102. The support 102 is a metal beam, with an entrance attachment plate 106, an exit attachment plate 107, rod mounts 108, a chain mount weldment 109, and a clevis mount weldment 110.

FIG. 4 shows a brush 101. The brush 400 has a base 401 and a plurality of bristles 402. The base 401 has a brush orifice 403 for receiving a hollow shaft 500. The brush 101 may have about a five inch diameter. However, in other embodiments, the brush 101 may have a smaller or larger diameter. The brush orifice 403 is substantially circular, with a diameter of about one inch, However, in other embodiments, the brush orifice 403 may have a larger or smaller diameter.

FIG. 5 shows the hollow shaft 500. It has a brush shaft 501 for insertion into the brush orifice 403 and a shaft orifice 502 for delivering the flu id to die brush 101.

FIG. 6 shows a drive gear 600 for an apparatus for applying a fluid to tires of a vehicle, in accordance with an illustrative embodiment. The drive gear 600 may comprise a plurality of drive gear teeth 601. The drive gear 600 may be connected to a drive brush. The drive gear teeth 601 engage with brush gear teeth 701 on at least another brush gear 105, shown in FIG. 7. The brush gears 105 each connect to a brush. The motor may cause drive gear 600 to rotate, which in turn causes interengaged brush gears 105 to rotate. The drive gear 600 and/or the brush gear 105 may be plastic gears.

While the invention has been described above according to its preferred embodiments, it can be modified within the spirit and scope of this disclosure. This application is therefore intended to cover any variations, uses, or adaptations of the invention using the general principles disclosed herein. Further, the application is intended to cover such departures from the present disclosure as come within the known or customary practice in the art to which this invention pertains and which fall within the limits of the following claims.

What is claimed is:

1. An apparatus for dressing or cleaning tires of a vehicle, said apparatus comprising:
a support;
a plurality of brushes mounted to said support generally in a line relative to a path of a tire travelling said line;
at least some of said brushes being mounted to said support to rotate;
a motor; and
a drive train assembly, said drive train assembly being connected to said motor and to said brushes mounted to rotate.

2. The apparatus of claim 1, further including a liquid conduit structure, said conduit structure conveying a fluid to at least some of said brushes.

3. The apparatus of claim 2, wherein hollow shafts deliver the fluid to said brushes and said brushes which rotate are mounted on said hollow shafts.

4. An apparatus for dressing or cleaning tires of a vehicle, said apparatus comprising:
a support adapted to be mounted adjacent to and parallel to a path of tire travel;
a plurality of hollow shafts, each adapted to be mounted to the support and substantially perpendicular to the path of tire travel;
a plurality of brushes mounted to the plurality of hollow shafts in a serial relationship, wherein the brushes comprise a plurality of bristles and wherein the bristles are substantially perpendicular to the path of tire travel;
a drive motor; and
a plurality of gears which interconnect the plurality of brushes and team a drive train to rotate said brushes.

5. An apparatus for applying a fluid to tires of a vehicle, said apparatus comprising:
a plurality of left brushes and a plurality of right brushes having opposed inner surfaces, each of said inner surfaces engageable with at least one tire on left and right sides of the vehicle, respectively, said brushes having outer surfaces mounted respectively to left and right supports, said left brushes being engageable with at least one tire on a left side of said vehicle, said right brushes being engageable with at least one tire on a right side of said vehicle;
a left motor and a right motor for rotating said left brushes and said right brushes, respectfully, wherein said left brushes and said right brushes are arranged serially and are connected to each other by a plurality of left gears and a plurality of right gears, respectively; and
a plurality of hollow shafts for mounting said left brushes to the left support and said right brushes to the right support and for delivering said fluid to said left brushes and said right brushes.

6. An apparatus for dressing or cleaning tires of a vehicle in a carwash, comprising:
a mount having a long dimension;
a plurality of brushes carried on said mount at least some of which are arranged generally along said long dimension, said brushes having an axis extending away from and on a side of said mount;
some or all of said brushes being mounted to rotate on said axis;
a drive train connected to said brushes which are mounted to rotate; and
motor connected to said drive train driving said brushes which are mounted to rotate.

7. The apparatus of claim 6 further including a conduit structure through which fluid is carried to some or all of said brushes for use in dressing or cleaning the tires.

8. The apparatus of claim 7 wherein said brushes are mounted to rotate on axles, said axles including said conduit structure therein through which said fluid is conveyed to an interior part of said brushes.

9. The apparatus of claim 8 wherein said axles are hollow.

10. The apparatus of claim 6 wherein said brushes are closely adjacent one another.

11. The apparatus of claim 6 wherein said brushes are closely adjacent one another generally in a line.

12. The apparatus of claim 11 wherein said line is substantially straight, and generally parallel to a path of travel of the vehicle traversing said apparatus.

13. The apparatus of claim 12 wherein said line is generally horizontal relative to the ground.

14. The apparatus of claim 11 wherein said brushes have an effective diameter at a point of contact with a tire of about six inches or less.

15. The apparatus of claim 7 further including a movable frame for said mount, said movable frame including structure carrying said mount thereon and moving said mount toward and away from a path of travel of the vehicle.

16. The apparatus of claim 7 wherein mounts with brushes are provided for opposite sides of a vehicle travelling between the same.
